(19) United States
(12) Patent Application Publication
(10) Pub. No.: US 2015/0268511 A1
(43) Pub. Date: Sep. 24, 2015

(54) COLOR FILTER SUBATRATE AND DISPLAY PANEL

(71) Applicant: Au Optronics Corporation, Hsinchu (TW)

(72) Inventors: Chia-Chun Hsu, Taoyuan County (TW); Yu-Ping Kuo, New Taipei City (TW); Ching-Sheng Cheng, Kaohsiung City (TW)

(73) Assignee: Au Optronics Corporation, Hsinchu (TW)

(21) Appl. No.: 14/280,690

(22) Filed: May 19, 2014

(30) Foreign Application Priority Data
Mar. 19, 2014 (TW) 103110327

(51) Int. Cl. G02F 1/1335; G02F 1/1343; G02B 5/20; G02F 1/1337

(52) U.S. Cl. CPC G02F 1/133514; G02F 1/1337; G02F 1/134309; G02B 5/201; G02F 2001/134345

(57) ABSTRACT

A color filter substrate is provided. The color filter substrate has a plurality of first sub-pixel areas and a plurality of second sub-pixel areas. The color filter substrate includes a first substrate, a plurality of first filters, a plurality of second filters, and a plurality of protrusions. The plurality of first filters are disposed on the first substrate and respectively located in the plurality of first sub-pixel areas. The plurality of second filters is disposed on the first substrate and respectively located in the plurality of second sub-pixel areas. The color of the first filters is different from that of the second filters. The protrusions are disposed on the first substrate and adjacent to two of the first sub-pixel areas adjacent to each other.

### CROSS-REFERENCE TO RELATED APPLICATION

This application claims the priority benefit of Taiwan application serial no. 103110327, filed on Mar. 19, 2014. The entirety of the above-mentioned patent application is hereby incorporated by reference herein and made a part of this specification.

### BACKGROUND OF THE INVENTION

1. Field of the Invention

The invention relates to a substrate and a display apparatus, and more particularly, to a color filter substrate and a display panel.

2. Description of Related Art

A liquid crystal display panel has gradually become the mainstream in the market due to superior characteristics such as high image quality, good space utilization efficiency, low power consumption, no radiation, etc. In a process of manufacturing, for example, an in-plane switching (IPS) or a twisted nematic liquid crystal display panel, an alignment layer is needed to be formed on two substrates, so as to provide an anchoring force to liquid crystal molecules and to arrange the liquid crystal molecules in a specific direction.

A conventional method of forming the alignment layer is to first coat the alignment materials on the substrate, and then to perform alignment to the alignment materials. Known alignment techniques include contact alignment techniques and non-contact alignment techniques, wherein the contact alignment technique such as a rubbing technique may provide a good anchoring effect to the liquid crystal molecules. However, as shown in FIG. 5, due to the presence of protrusions PS, a problem that the surface of the conventional alignment layer 150 is uneven may be produced. When the rubbing technique is used to form alignment patterns on the alignment layer 150, light leakage areas are easy to be formed surrounding the protrusions such that an overall contrast ratio of the display panel is reduced. Therefore, how to develop the display panel with higher contrast ratio is one of the goals that developers desire to achieve.

### SUMMARY OF THE INVENTION

The invention provides a color filter substrate, which improves a phenomenon of light leakage.

The invention provides a display panel, which improves a problem of poor contrast ratio.

The color filter substrate of the invention has a plurality of first sub-pixel areas and a plurality of second sub-pixel areas. The color filter substrate includes a first substrate, a plurality of first filters, a plurality of second filters, and a plurality of protrusions. The plurality of first filters are disposed on the first substrate and respectively located in the plurality of first sub-pixel areas. The plurality of second filters are disposed on the first substrate and respectively located in the plurality of second sub-pixel areas, wherein a color of the first filters is different from a color of the second filters. The plurality of protrusions are disposed on the first substrate and are adjacent to two of the first sub-pixel areas adjacent to each other.

The display panel of the invention has a plurality of first sub-pixel areas and a plurality of second sub-pixel areas. The display panel includes a first substrate, a second substrate, a plurality of first filters, a plurality of second filters, and a plurality of protrusions. The plurality of first filters are disposed on the first substrate and are respectively located in the first sub-pixel areas. The plurality of second filters are disposed on the first substrate and are respectively located in the second sub-pixel areas, wherein a color of the first filters is different from a color of the second filters. The plurality of protrusions are disposed between the first substrate and the second substrate and are adjacent to two of the first sub-pixel areas adjacent to each other.

The other display panel of the invention has a plurality of first sub-pixel areas and a plurality of second sub-pixel areas. The display panel includes a first substrate, a second substrate, a plurality of first filters, a plurality of second filters, and a plurality of protrusions. The plurality of first filters are disposed on the first substrate and are respectively located in first sub-pixel areas. The plurality of second filters are disposed on the first substrate and are respectively located in the second sub-pixel areas, wherein a color of the first filters is different from a color of the second filters. The plurality of protrusions are disposed between the first substrate and the second substrate and are disposed only within distribution regions of the first filters respectively.

According to the above, in the color filter substrate of the invention, the protrusions are adjacent to two of the first sub-pixel areas adjacent to each other, such that the contrast ratio of the display panel is effectively enhanced.

In order to make the aforementioned and other features and advantages of the invention comprehensible, embodiments accompanied with figures are described in detail below.

### BRIEF DESCRIPTION OF THE DRAWINGS

FIG. 1 illustrates a schematic cross-sectional diagram of a display panel according to an embodiment of the invention.

FIG. 2 illustrates a schematic diagram of a top view of the display panel in FIG. 1.

FIG. 3 illustrates an enlarged schematic diagram of a region K of the display panel in FIG. 2.

FIG. 4 illustrates a top view of a conventional color filter substrate.

FIG. 5 illustrates a schematic cross-sectional diagram along a line A-A′ of the conventional color filter substrate in FIG. 4.

FIG. 6 illustrates a top view of a color filter substrate according to the first embodiment of the invention.

FIG. 7 illustrates a schematic cross-sectional diagram along a line I-I′ of the color filter substrate in FIG. 6.

FIG. 8 illustrates a top view of a color filter substrate according to the second embodiment of the invention.

FIG. 9 illustrates a top view of a color filter substrate according to the third embodiment of the invention.

FIG. 10 illustrates a top view of a color filter substrate according to the forth embodiment of the invention.

FIG. 11 illustrates a top view of a color filter substrate according to the fifth embodiment of the invention.

### DESCRIPTION OF EMBODIMENTS

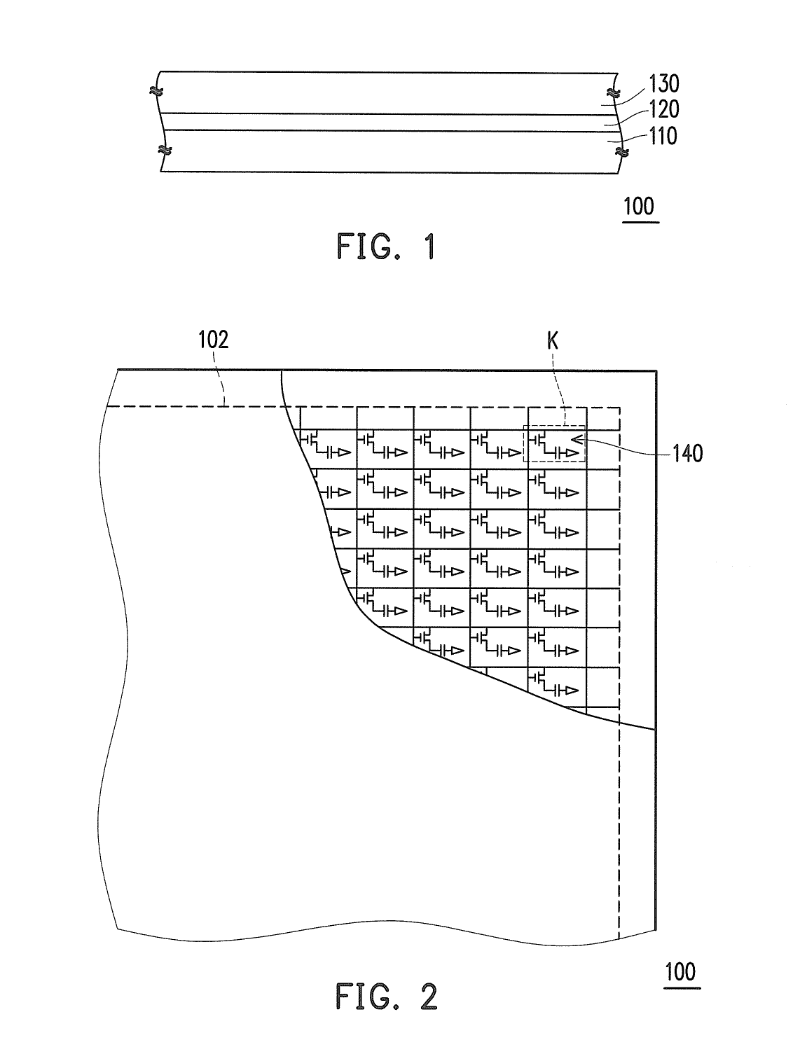

FIG. 1 illustrates a schematic cross-sectional diagram of a display panel according to an embodiment of the invention. FIG. 2 illustrates a schematic diagram of a top view of the display panel in FIG. 1. As shown in FIG. 1 and FIG. 2, the display panel 100 includes a second substrate 110 (which is exemplified as an active device array substrate herein), a display medium 120, and a first substrate 130. The display medium 120 is, for example, located between the first substrate 130 and the second substrate 110. A type of the display panel 100 is not limited in the present embodiment, wherein the display panel 100 may have different modes according to different display medium 120. For example, the display panel 100 is a liquid crystal display panel when the display medium 120 is a liquid crystal material. The liquid crystal display panel is exemplified in the following to illustrate the display panel 100 of the present embodiment.

A material of the second substrate 110 may be glass, quartz, or organic polymers, etc. As shown in FIG. 2, the display panel 100 includes a display area 102. Images are displayed in the display area 102 of the display panel 100, such that components for displaying the images (such as a pixel structure 140 and the display medium 120) of the display panel 100 are disposed in the display area 102. As shown in FIG. 2, a pixel array is formed in the display area 102 with the pixel structures 140. For clarity, only a part of the members of the pixel structure 140 are illustrated in FIG. 2. The members of the pixel structure 140 and the detailed structure thereof are described in more detail below with reference to the drawings.

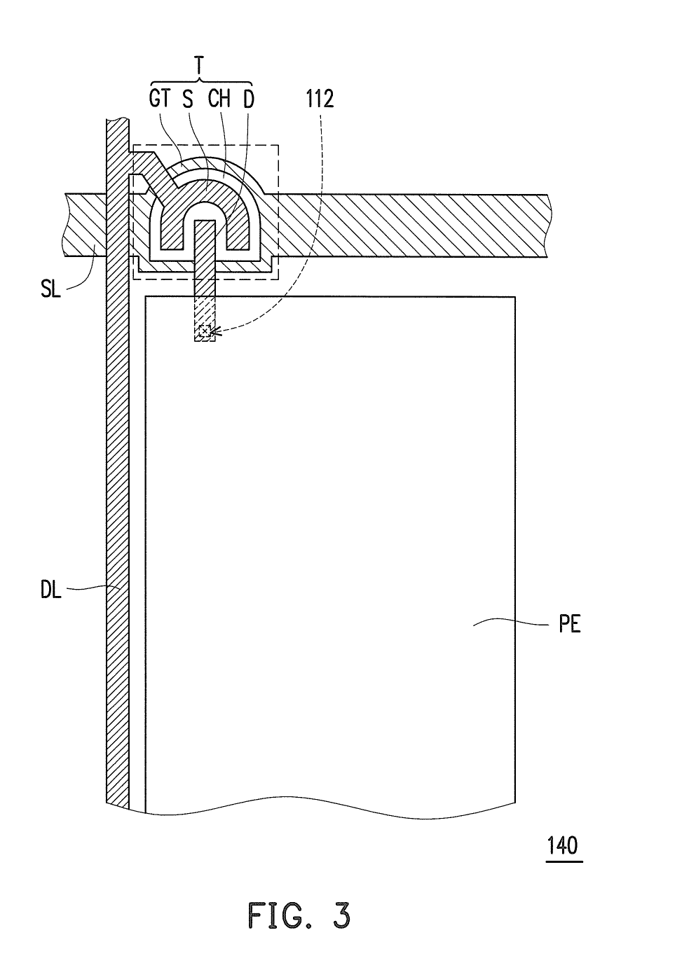

FIG. 3 illustrates an enlarged schematic diagram of a region K of the display panel in FIG. 2. Please refer to FIG. 3, the pixel structure 140 includes a scan line SL, a data line DL, an active device T, and a pixel electrode PE.

The extending directions of the scan line SL and the data line DL are different. Commonly, the extending direction of the scan line SL is perpendicular to the extending direction of the data line DL. Furthermore, the scan line SL and the data line DL are located on the different films and an insulating layer (not shown) is interposed therebetween. The scan line SL and the data line DL are mainly for transmitting driving signals which drive the pixel structure 140. A metal material is generally used for the scan line SL and the data line DL, but the invention is not limited thereto. According to other embodiments, other conductive materials such as alloys, metal oxides, metal nitrides, metal oxynitrides, or stacked layers of metal materials and other conductive materials may also be used for the scan line SL and the data line DL.

The active device T is electrically connected to the corresponding scan line SL and the corresponding data line DL. Herein, the active device T could be a thin film transistor, which includes a gate GT, a channel layer CH, a drain D, and a source S. The gate GT is electrically connected to the scan line SL. The source S is electrically connected to the data line DL. In other words, the scan line SL is electrically connected to the gate GT when a control signal is inputted into the scan line SL. The data line DL is electrically connected to the source S when the control signal is inputted into the data line DL. The channel layer CH is located above the gate GT and under the source S and the drain D for example. For illustration, the active device T in the present embodiment is exemplified as a bottom-gate type thin film transistor, but the invention is not limited thereto. In other embodiments, the active device T may also be a top-gate type thin film transistor.

Please refer to FIG. 1 and FIG. 3 simultaneously. The first substrate 130 is located opposite to the second substrate 110. A plurality of color filters such as red color filters, green color filters, and blue color filters are disposed on the first substrate 130. Or, the plurality of color filters may also be manufactured on the second substrate 110 instead of being manufactured on the first substrate 130. Generally, in examples of which the color filters are manufactured on the second substrate 110, the second substrate 110 is a color filter on array (COA) substrate when the color filters are located above the active device T; the second substrate 110 is an array on color filter (AOC) substrate when the color filters are located under the active device T. A material of the first substrate 130 may be glass, quartz, or organic polymers, etc. In addition, a black matrix (BM) may be further disposed on the first substrate 130. The black matrix has a plurality of openings, wherein the color filters are disposed in the openings.

As shown in FIG. 3, the pixel electrode PE is electrically connected to the corresponding active device T. More specifically, the pixel electrode PE may be electrically connected to the drain D of the active device T through a contact hole 112. The pixel electrode PE could be a transparent conductive layer which includes metal oxides, for example, indium tin oxides, indium zinc oxides, aluminum tin oxides, aluminum zinc oxides, indium germanium zinc oxides or other suitable oxides, or stacked layers of at least two of the above.

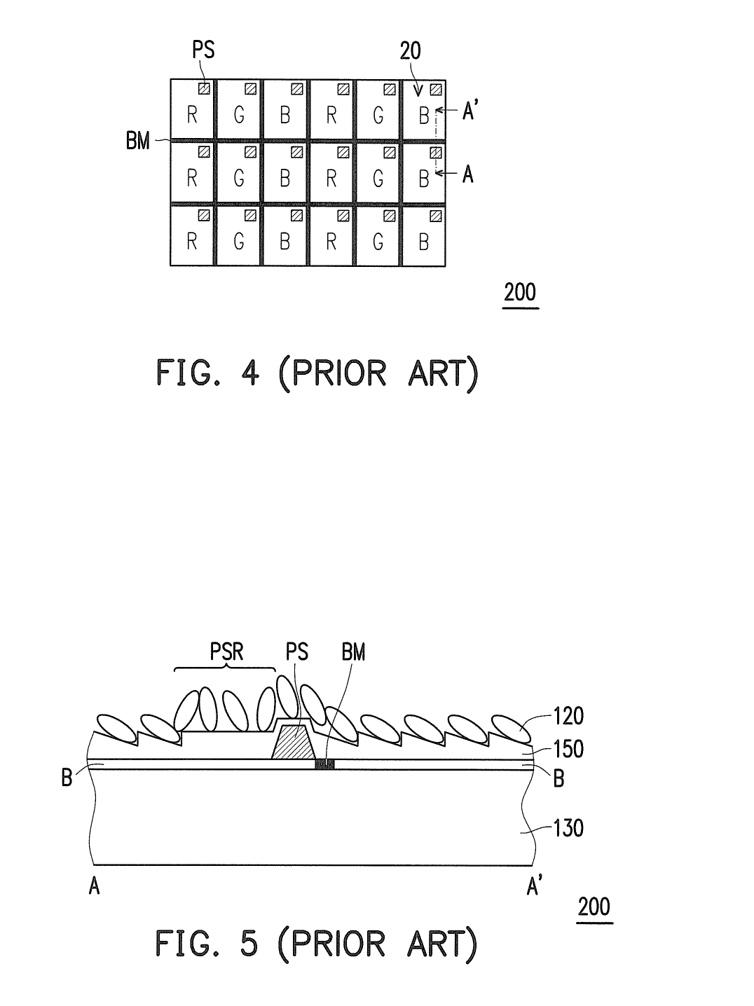

FIG. 4 illustrates a top view of a conventional color filter substrate. FIG. 5 illustrates a schematic cross-sectional diagram along a line A-A′ of the conventional color filter substrate in FIG. 4. Please refer to FIG. 4 and FIG. 5 simultaneously. The plurality of color filters R, G, B and the black matrix BM which has a light-shading effect are disposed on the first substrate 130. Generally, as shown in FIG. 4, the plurality of sub-pixel areas 20 of the conventional display panel are arranged in an order of the red color filter R, the green color filter G, and the blue color filter B. Furthermore, the protrusions PS are disposed on the first substrate 130 and are respectively located in each sub-pixel areas 20. In addition, an alignment layer 150 is further disposed on the color filters R, G, B, and the protrusions PS. Due to a presence of the plurality of protrusions PS, the alignment layer 150 which is located surrounding the protrusions PS protrude relatively in a direction perpendicular to a rubbing direction, which makes the display medium 120 around the protrusions PS easy to be tilted abnormally. Further, a light leakage areas PSR is formed such that an overall contrast ratio of the display panel is reduced.

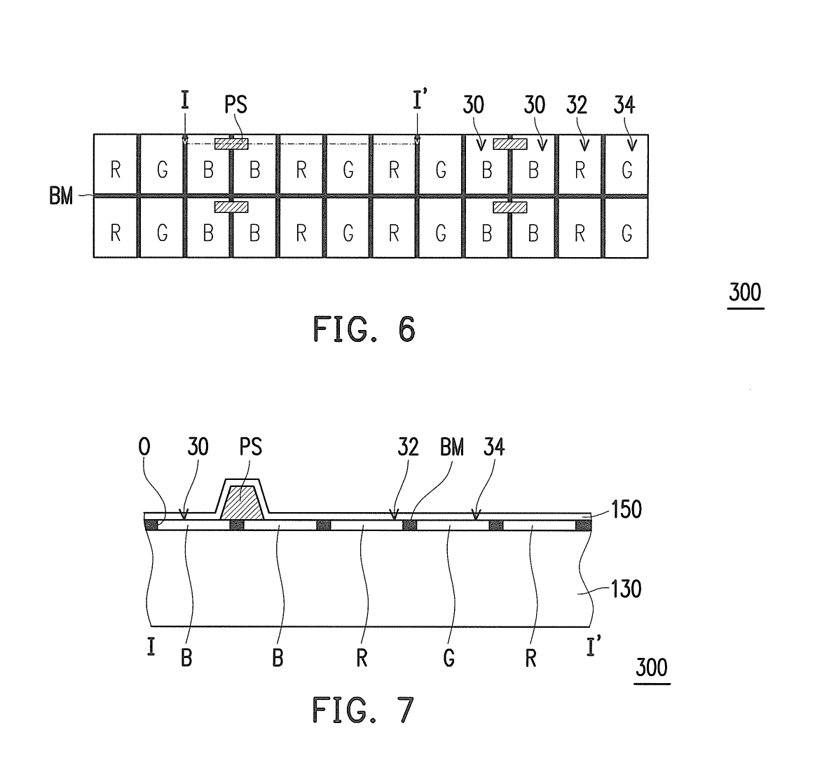

FIG. 6 illustrates a top view of a color filter substrate according to the first embodiment of the invention. FIG. 7 illustrates a schematic cross-sectional diagram along a line I-I′ of the color filter substrate in FIG. 6. Please refer to FIG. 6 and FIG. 7 simultaneously. A color filter substrate 300 has a plurality of first sub-pixel areas 30, a plurality of second sub-pixel areas 32, and a plurality of third sub-pixel areas 34. The first substrate 130 includes the plurality of first filters B, the second filters R, and the third filters G thereon. The first filters B are located in the first sub-pixel areas 30, the second filters R are located in the second sub-pixel areas 32, and the third filters G are located in the third sub-pixel areas 34. It should be noted that, the color of the first filters B is different from the color of the second filters R, and the color of the first filters B is different from the color of the third filters G. For example, in the present embodiments, the first filters B are the blue color filters, the second filters R are the red color filters, and the third filters G are the green color filters. However, the embodiment is not limited thereto. The color filter substrate 300 may only include the plurality of first sub-pixel areas 30 and the plurality of second sub-pixel areas 32, wherein the first filters B are located in the first sub-pixel areas 30 and the second filters R are located in the second sub-pixel areas 32. In this case, the color of the first filters B is different from the color of the second filters R. For example, the first filters B may be the blue color filters, and the second filters R may be the red color filters.

As shown in FIG. 6, the color filters on the color filter substrate 300 are repeatedly arranged in an order of the second filters R, the third filters G, the first filters B, the first filters B, the second filters R, and the third filters G. It is worth mentioning that each of the protrusions PS is only disposed in two of the first sub-pixel areas 30 adjacent to each other, instead of being adjacent to other sub-pixel areas. By the design, comparing to the conventional color filter substrate 200 in FIG. 4 of which the protrusions PS are disposed in each sub-pixel areas 20, in the present embodiment, a total length of sides surrounding the protrusions PS on the color filter substrate 300 may be reduced, which may further reduce a dimension of the light leakage areas PSR as shown in FIG. 5 such that the overall contrast ratio of the display panel is increased. It is worth mentioning that the present embodiment is not limited thereto. In addition to dispose the protrusion PS in two of the first sub-pixel areas 30 adjacent to each other, each of the protrusions PS of the embodiment may not be disposed within both of the first sub-pixel areas 30 and the second sub-pixel areas 32 which are adjacent to each other. For example, the protrusions PS are not adjacent to the first filters B in the first sub-pixel areas 30 and the second filters R in the second sub-pixel areas 32 which are adjacent to the first sub-pixel areas 30. Accordingly, the total number of the protrusions PS may be further reduced, thereby reducing the light leakage areas PSR and increasing the overall contrast ratio of the display panel.

Generally, ratios of light leakage in a dark sate of red light, green light, and blue light are 17%, 77%, and 6%, respectively. It is worth mentioning that, in a case that the first filters B of the present embodiment are the blue color filters, by disposing each of the protrusions PS in two of the first filters B adjacent to each other, the ratio of light leakage of blue light may be slightly increased or maintained, and the ratios of light leakage of red light and green light are significantly reduced simultaneously, which may further enhance the contrast ratio of the display panel more effectively (about 8%).

As shown in FIG. 7, the alignment layer 150 may be further disposed on the first substrate 130 of the color filter substrate 300. The first filters B, the second filters R, the third filters G, and the protrusions PS are covered by the alignment layer 150. The black matrix BM with the light-shading effect may also be further disposed on the first substrate 130 of the color filter substrate 300. The black matrix BM has the plurality of openings O, wherein the first filters B, the second filters R, and the third filters G are respectively located in the openings O. A manufacturing process of the color filters is, for example, an ink jet printing process, by which a red pigment, a green pigment, and a blue pigment are injected into the openings O of the black matrix BM.

It is worth mentioning that, a size of the protrusions PS is 12 μm×12 μm in the present embodiment, but the present embodiment is not limited thereto. The size of the protrusions PS may also be reduced to 8.5 um×8.5 um, and in such case, the contrast ratio of the display panel may be further enhanced (about 13%).

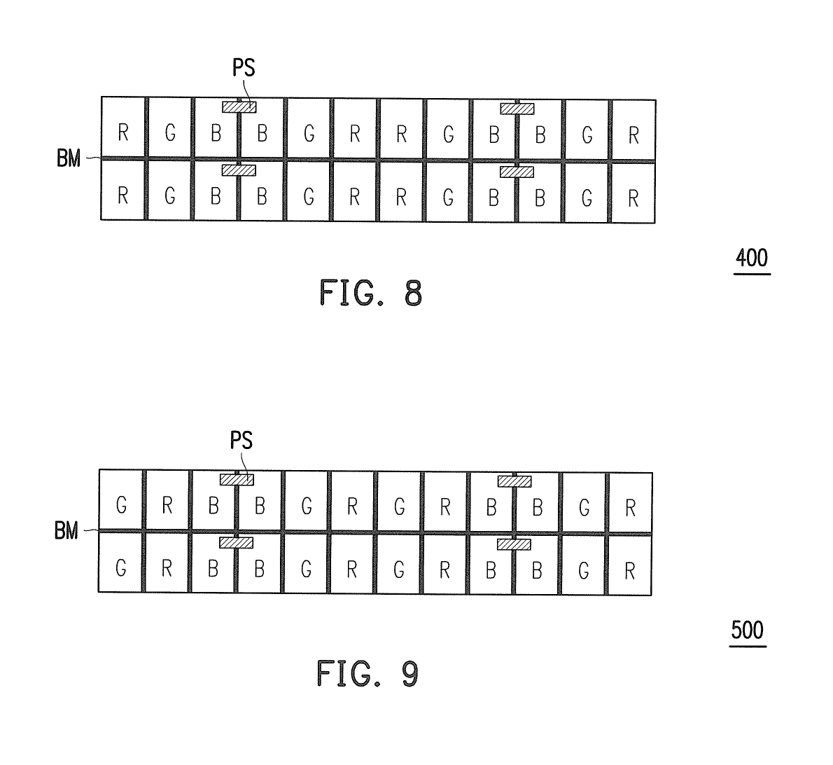

FIG. 8 illustrates a top view of a color filter substrate according to the second embodiment of the invention. Please refer to FIG. 8. A color filter substrate 400 of the present embodiment is similar to the color filter substrate 300 in FIG. 7, so that the same or the similar components are represented by the same or the similar component symbols, and illustrations thereof are not repeated. The difference between the color filter substrate 400 and the color filter substrate 300 is that, the color filters of the color filter substrate 400 are repeatedly arranged in an order of the second filters R (the red color filters), the third filters G (the green color filters), the first filters B (the blue color filters), the first filters B (the blue color filters), the third filters G (the green color filters), and the second filters R (the red color filters). Similarly, the protrusions PS of the present embodiment are disposed only within the distribution regions of the first filters B. In other words, the protrusions PS are partially overlapped or completely overlapped with the first filters B, and the protrusions PS are not overlapped with the second filters R and the third filters G. Or, the overlapping areas of the protrusions PS with the first filters B may be larger than the overlapping areas of the protrusions PS with the second filters R or the third filters G. In this way, the ratio of light leakage of the blue light may be slightly increased or maintained, and the ratios of light leakage of the red light and the green light are significantly reduced simultaneously. Therefore, the contrast ratio of the display panel may be effectively enhanced (about 8%). In addition, please refer to FIG. 4 and FIG. 8 simultaneously. Comparing to the color filter substrate 200, the blue color filters B of the color filter substrate 400 are adjacent to each other and the protrusions PS are disposed in the distribution regions of two of the first filters B adjacent to each other, such that the total quantity of the protrusions PS may be reduced and the overall ratio of light leakage of the display panel may be further reduced. In the present embodiment, the size of the protrusions PS is 12 μm×12 μm, but the present embodiment is not limited thereto. The size of the protrusions PS may also be reduced to 8.5 um×8.5 um, and in such case, the contrast ratio of the display panel may be further enhanced (about 13%).

FIG. 9 illustrates a top view of a color filter substrate according to the third embodiment of the invention. Please refer to FIG. 9. A color filter substrate 500 of the present embodiment is similar to the color filter substrate 300 in FIG. 7, so that the same or the similar components are represented by the same or the similar component symbols, and illustrations thereof are not repeated. The difference between the color filter substrate 500 and the color filter substrate 300 is that, the color filters of the color filter substrate 500 are repeatedly arranged in an order of the third filters G (the green color filters), the second filters R (the red color filters), the first filters B (the blue color filters), the first filters B (the blue color filters), the third filters G (the green color filters), and the second filters R (the red color filters). Similarly, by disposing the protrusions PS only within the distribution regions of the first filters B, the ratio of light leakage of the blue light may be slightly increased or maintained, and the ratios of light leakage of the red light and the green light are significantly reduced simultaneously. Therefore, the contrast ratio of the display panel may be effectively enhanced (about 8%). In addition, please refer to FIG. 4 and FIG. 9 simultaneously. Comparing to the color filter substrate 200, the first filters B (the blue color filters) of the color filter substrate 500 are adjacent to each other and the protrusions PS are disposed in the distribution regions of two of the first filters B (the blue color filters) adjacent to each other, such that the total quantity of the protrusions PS may be reduced and the overall ratio of light leakage of the display panel may be further reduced. In the present embodiment, the size of the protrusions PS is 12 μm×12 μm, but the present embodiment is not limited thereto. The size of the protrusions PS may also be reduced to 8.5 um×8.5 um, and in such case, the contrast ratio of the display panel may be further enhanced (about 13%).

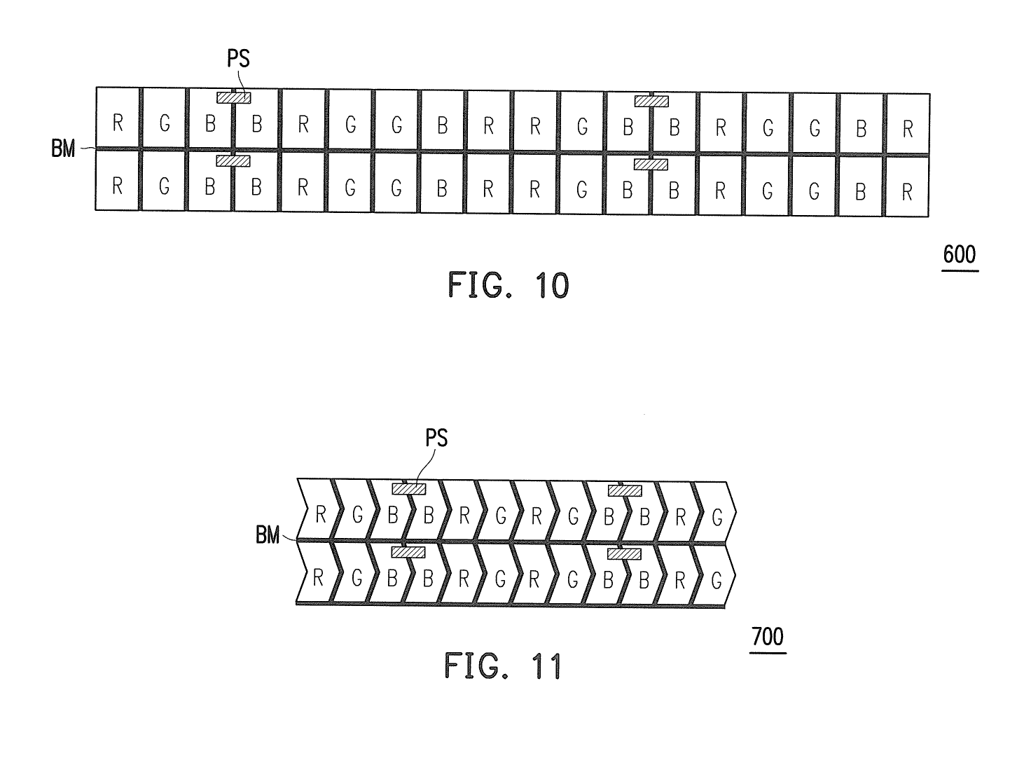

FIG. 10 illustrates a top view of a color filter substrate according to the forth embodiment of the invention. Please refer to FIG. 10. A color filter substrate 600 of the present embodiment is similar to the color filter substrate 300 in FIG. 7, so that the same or the similar components are represented by the same or the similar component symbols, and illustrations thereof are not repeated. The difference between the color filter substrate 600 and the color filter substrate 300 is that, the color filters of the color filter substrate 600 are repeatedly arranged in an order of the second filters R (the red color filters), the third filters G (the green color filters), the first filters B (the blue color filters), the first filters B (the blue color filters), the second filters R (the red color filters), the third filters G (the green color filters), the third filters G (the green color filters), the first filters B (the blue color filters), and the second filters R (the red color filters). Similarly, by disposing the protrusions PS only within the distribution regions of the first filters B (the blue color filters), the ratio of light leakage of the blue light may be slightly increased or maintained, and the ratios of light leakage of the red light and the green light are significantly reduced simultaneously. Therefore, the contrast ratio of the display panel may be effectively enhanced (about 8%). In addition, please refer to FIG. 4 and FIG. 10 simultaneously. Comparing to the color filter substrate 200, the first filters B (the blue color filters) of the color filter substrate 600 are adjacent to each other and the protrusions PS are disposed in the distribution regions of two of the first filters B (the blue color filters) adjacent to each other, such that the total quantity of the protrusions PS may be reduced and the overall ratio of light leakage of the display panel may be further reduced. In the present embodiment, the size of the protrusions PS is 12 μm×12 μm, but the present embodiment is not limited thereto. The size of the protrusions PS may also be reduced to 8.5 um×8.5 um, and in such case, the contrast ratio of the display panel may be further enhanced (about 13%).

FIG. 11 illustrates a top view of a color filter substrate according to the fifth embodiment of the invention. Please refer to FIG. 11. A color filter substrate 700 of the present embodiment is similar to the color filter substrate 300 in FIG. 7, so that the same or the similar components are represented by the same or the similar component symbols, and illustrations thereof are not repeated. It is worth mentioning that, the color filters of the embodiments in FIG. 6 to FIG. 10 are square whereas the color filters of the color filter substrate 700 of the present embodiment are illustrated in FIG. 11, but the present embodiment is not limited thereto. Similarly, the color filters of the color filter substrate 700 are repeatedly arranged in an order of the second filters R (the red color filters), the third filters G (the green color filters), the first filters B (the blue color filters), the first filters B (the blue color filters), the second filters R (the red color filters), and the third filters G (the green color filters). Similarly, by disposing the protrusions PS only within the distribution regions of the first filters B (the blue color filters), the ratio of light leakage of the blue light may be slightly increased or maintained, and the ratios of light leakage of the red light and the green light are significantly reduced simultaneously. Therefore, the contrast ratio of the display panel may be effectively enhanced (about 8%). In addition, please refer to FIG. 4 and FIG. 11 simultaneously. Comparing to the color filter substrate 200, the first filters B (the blue color filters) of the color filter substrate 700 are adjacent to each other and the protrusions PS are disposed in the distribution regions of two of the first filters B (the blue color filters) adjacent to each other, such that the total quantity of the protrusions PS may be reduced and the overall ratio of light leakage of the display panel may be further reduced. In the present embodiment, the size of the protrusions PS is 12 μm×12 μm, but the present embodiment is not limited thereto. The size of the protrusions PS may also be reduced to 8.5 um×8.5 um, and in such case, the contrast ratio of the display panel may be further enhanced (about 13%).

According to the above, the color filter substrate of the invention includes the plurality of protrusions, and the protrusions are adjacent to two of the blue sub-pixel areas adjacent to each other, such that the contrast ratio of the display panel may be effectively enhanced. In addition, the total quantity of the protrusions may be reduced through the disposition mentioned above, which may further reduce the overall ratio of light leakage of the display panel.

It will be apparent to those skilled in the art that various modifications and variations can be made to the structure of the disclosed embodiments without departing from the scope or spirit of the invention. In view of the foregoing, it is intended that the disclosure cover modifications and variations of this specification provided they fall within the scope of the following claims and their equivalents.

What is claimed is:

1. A color filter substrate, having a plurality of first sub-pixel areas and a plurality of second sub-pixel areas, comprising:
a first substrate;
a plurality of first filters, disposed on the first substrate and respectively located in the first sub-pixel areas;
a plurality of second filters, disposed on the first substrate and respectively located in the second sub-pixel areas, wherein a color of the first filters is different from a color of the second filters; and
a plurality of protrusions, disposed on the first substrate and adjacent to two of the first sub-pixel areas adjacent to each other.

2. The color filter substrate as claimed in claim 1, wherein each of the protrusions is not adjacent to one of the first sub-pixel areas and one of the second sub-pixel areas adjacent to each other.

3. The color filter substrate as claimed in claim 1, further comprising an alignment layer, disposed on the first substrate and covering the first filters, the second filters and the protrusions.

4. The color filter substrate as claimed in claim 1, further comprising a plurality of third sub-pixel areas, the color filter substrate further comprising a plurality of third filters disposed on the first substrate and respectively located in the third sub-pixel areas, wherein the color of the first filters is different from a color of the third filters, and the first filters are blue color filters.

5. The color filter substrate as claimed in claim 4, wherein the second filters are red color filters, the third filters are green color filters, and the first filters, the second filters and the third filters which are arranged in a series are repeatedly arranged in an order of the red color filters, the green color filters, the blue color filters, the blue color filters, the red color filters, and the green color filters.

6. The color filter substrate as claimed in claim 4, wherein the second filters are red color filters, the third filters are green color filters, and the first filters, the second filters and the third filters which are arranged in a series are repeatedly arranged in an order of the red color filters, the green color filters, the blue color filters, the blue color filters, the green color filters, and the red color filters.

7. The color filter substrate as claimed in claim 4, wherein the second filters are red color filters, the third filters are green color filters, and the first filters, the second filters and the third filters which are arranged in a series are repeatedly arranged in an order of the red color filters, the green color filters, the blue color filters, the blue color filters, the red color filters, the green color filters, the green color filters, the blue color filters, and the red color filters.

8. The color filter substrate as claimed in claim 1, further comprising a plurality of scan lines, a plurality of data lines, a plurality of pixel electrodes and a plurality of active devices disposed on the first substrate, wherein the active devices are electrically connected to the corresponding scan lines and the corresponding data lines, and the pixel electrodes are electrically connected to the corresponding active devices.

9. The color filter substrate as claimed in claim 1, further comprising a black matrix, disposed on the first substrate and has a plurality of openings, wherein the first filters and the second filters are located in the openings respectively.

10. A display panel, having a plurality of first sub-pixel areas and a plurality of second sub-pixel areas, comprising:
a first substrate;
a second substrate;
a plurality of first filters, disposed on the first substrate and respectively located in the first sub-pixel areas;
a plurality of second filters, disposed on the first substrate and respectively located in the second sub-pixel areas, wherein a color of the first filters is different from a color of the second filters; and
a plurality of protrusions, disposed between the first substrate and the second substrate and adjacent to two of the first sub-pixel areas adjacent to each other.

11. The display panel as claimed in claim 10, further comprising a display medium located between the first substrate and the second substrate.

12. The display panel as claimed in claim 10, further comprising an alignment layer disposed on the first substrate and covering the protrusions.

13. A display panel, having a plurality of first sub-pixel areas and a plurality of second sub-pixel areas, comprising:
a first substrate;
a second substrate;
a plurality of first filters, disposed on the first substrate and respectively located in the first sub-pixel areas;
a plurality of second filters, disposed on the first substrate and respectively located in the second sub-pixel areas, wherein a color of the first filters is different from a color of the second filters; and
a plurality of protrusions, disposed between the first substrate and the second substrate and disposed only within distribution regions of the first filters respectively.

14. The display panel as claimed in claim 13, wherein overlapping areas of the protrusions with the first filters are larger than overlapping areas of the protrusions with the second filters.

15. The display panel as claimed in claim 13, wherein the first filters are blue color filters.
